(19) United States
(12) Patent Application Publication
(10) Pub. No.: US 2003/0143078 A1
(43) Pub. Date: Jul. 31, 2003

(54) Rotor or rotor element for a turbocompressor

(76) Inventors: Dante Benedetto, Awans (BE); Jack-Pierre Lauvergnat, Savigny Le Temple (FR)

Correspondence Address: KNOBBE MARTENS OLSON & BEAR LLP, 2040 MAIN STREET, FOURTEENTH FLOOR, IRVINE, CA, 92614, US

(21) Appl. No.: 10/323,863

(22) Filed: Dec. 17, 2002

(30) Foreign Application Priority Data
Dec. 17, 2001 (EP) 01870278.7

(51) Int. Cl. F03B 3/12

(52) U.S. Cl. 416/219 R

(57) ABSTRACT

A rotor element for a turbocompressor having at least one rotor stage supporting a series of mobile blades that do not have a platform separating the aerofoil from the root of the blade. At least one recess is provided in order to allow the engagement of the roots of the mobile blades, wherein the rotor element comprises at least two consecutive individual rings having at their lateral periphery one annular half-profile which, during the axial juxtaposition of the two individual rings, form a complete recess in which the roots of the series of mobile blades are engaged.

### FOREIGN PRIORITY

This application claims priority to European Patent Application number EP 01870278.7, filed Dec. 17, 2001, the disclosure of which is incorporated herein by reference in its entirety.

### BACKGROUND

1. Subject of the Invention

The present invention relates to compressors, especially to turbocompressors. More particularly, it relates to the rotors of turbocompressors.

2. State of the Art

Turbocompressors are well known in the prior art and are particularly used for twin-spool engines, turboblowers and turbojets.

These turbocompressors, which can be of the low-pressure type or of the high-pressure type, are essentially made up of a series of rotor stages comprising mobile blades alternating with stator stages comprising fixed blades (likewise referred to as guide-vane stages).

In the case of low-pressure compressors, the series of mobile blades of the different successive rotor stages of the compressors are fixed on one single rotor element or rotor. A series of recesses is machined at the periphery of said rotor, allowing the roots of the mobile blades of the different rotor stages to be mounted in it.

In the case where a rotor is common to several rotor stages, e.g. three or four, this rotor will comprise several annular recesses arranged on its periphery.

More precisely, the rotor will thus comprise a first recess arranged in a circle according to a first radius, in which a first series of mobile blades will be arranged in such a way as to form a first rotor stage.

The rotor will then comprise a second recess arranged at some distance from the first recess (corresponding to the width of a guide-vane stage), in which a second series of mobile blades will be arranged in such a way as to form a second rotor stage and so on.

However, in order to enable the roots of the series of mobile blades to be mounted in the annular recess, this recess is provided with at least one radial notch or opening that allows the successive insertion of the roots of the series of mobile blades.

Once the last blade in the series has been positioned, appropriate locking means, such as latches, are used to lock the root of this last mobile blade. These locking means likewise allow to avoid any displacement of the roots of the series of mobile blades within the annular recess itself.

This design of known rotors is costly and complex to produce. Moreover, the openings or notches pierced in the bottom of the recesses particularly weaken the rotor, which of course represents an additional drawback.

Finally, the locking means and in particular the latches used to immobilise the blades in the corresponding recesses lead to disturbances in the aerodynamic stream of the fluid, which leads to pressure losses and vibration that are detrimental to the proper functioning of the turbocompressor.

A final and very significant drawback of the presence of such locking devices is the ovalisation of the rotor after a certain period of operation.

Another significant problem consists in that the blades and in particular the mobile blades have a platform or plate located between the root and the aerofoil (body of the blade).

The purpose of this platform or plate is to increase the rigidity of the aerofoil/root assembly of the mobile blade.

Nevertheless, the main drawback of such a platform or plate is the presence of a double wall comprising a first wall corresponding to the web of the rotor and a second wall. Indeed, while ensuring the aerodynamic stream, this second wall generates an increase in material and mass at the level of the rotor.

It is well known to realize blades for turbine rotors that do not have a support platform on a disk or drum separating the aerofoil of the root of the blade (see documents DE-C-830 854 and GB-A-1 375 327).

The American patent U.S. Pat. No. 4,802,824 also proposes to have blades without platform and with roots having plane sides mounted on a turbine rotor so that the root of the blade is maintained in a broached pocket in the rotor by means of wedges arranged on both sides of the root of the blade. These wedges are extended by a crossbar and a platform. These platforms combine in pairs according to the circumference of the rotor in order to form a continuous collar realizing the aerodynamic stream. This solution is not advantageous relative to the realization of blades with platform. It does not solve the problem of the costly machining of the recesses in the rotor. Moreover, it does not solve the above-mentioned problem of the double wall either.

### SUMMARY OF THE INVENTION

The present invention aims to overcome the above-mentioned drawbacks of the rotors of known turbocompressors by providing a new design of rotor more particularly intended for a low-pressure compressor.

More precisely, the present invention aims to propose a solution which escapes the problem of a double wall created within a drum serving as a rotor and in particular within an integral or multi-part drum.

The present invention likewise aims to allow weight reduction and simpler production of the mobile blades.

Finally, the present invention aims to propose a solution in which the fixing of the mobile blades in the recesses of the rotor is simplified and does not require the use of locking elements such as latches, which generate disturbances.

The present invention relates to a rotor or rotor element for a turbocompressor, constituting the support of at least one rotor stage comprising mobile blades, in which at least one recess is provided in order to allow the engagement of the roots of a series of mobile blades, characterized in that said mobile blades do not have a platform or plate. This ensures that the blades are directly linked to a root being either dovetail-shaped or plane. This advantageously allows to eliminate the problem of the presence of a double wall for the aerodynamic stream while the turbocompressor is functioning.

In a particularly advantageous way, the rotor has additional characteristics which allow a further improvement in the present invention by making the aerodynamic stream more uniform. To this end, the presence of lateral notches for the introduction of the mobile blades and hence of latches is avoided.

To this effect, said rotor or rotor element comprises at least two individual rings including at their lateral periphery half-profiles which form a complete recess during the juxtaposition of the individual rings, in which the roots of a series of mobile blades are engaged. Each recess is determined by lips or edges.

The term “half-profile” is intended to mean a shape which laterally determines said ring and which allows to create again a complete recess with or without a bottom when two successive rings are abutted or juxtaposed.

This profile will possibly have the form of a half-pocket or half-channel or be plane.

According to a first embodiment, the invention relates to a rotor or rotor element for a turbocompressor comprising a single rotor stage with a single series of mobile blades.

According to this preferred embodiment, the rotor is essentially annular and is formed by two annular rings, which are juxtaposed. Half-profiles are laterally provided at the periphery of each of the rings in such a way that the half-profiles of one ring face the half-profiles of the consecutive ring so as to form the recess intended to receive the roots of the series of mobile blades of the rotor stage.

In order to assemble the blades on the rotor, it is consequently sufficient to move apart the two rings to open the recess, then to engage the roots of the blades in the half-profiles of one of the rings, then to juxtapose the two rings in order to close again the half-profiles constituting the recess and capture the roots of a series of successive mobile blades. The two rings are then firmly attached by own means.

The two rings of the rotor can advantageously be fixed by any appropriate known means and can preferably be untied. To this effect, they can be fixed for example by welding, or by means of rivets or of screws.

According to the invention however, the means to be used for fixing the rings is preferably removable. The use of a removable fixing means has the advantage of allowing the replacement of a damaged blade, for example.

To this effect, in an advantageous embodiment of the invention, the two consecutive rings are removably fixed to each other by an assembly of bolts and nuts passing through flanges firmly attached to said rings.

According to the present invention, the half-profiles of the ring have such a shape that the recess formed by the juxtaposition of the two half-profiles will have a shape that is complementary to the profile of the roots of the series of mobile blades which will be housed or engaged in said recess.

According to another embodiment, the half-profiles of the ring have the shape of half-pockets, such that the recess formed by the juxtaposition of the two half-profiles has a dovetail-shaped profile, which will correspond to the so-called formed profile roots of the series of mobile blades which will be housed or engaged in said recess.

Alternatively, the half-profiles of the rings are plane such that the recess formed by the juxtaposition of the two half-profiles has a groove that allows the rectilinear or plane roots of the series of mobile blades to be housed in them.

The immobilization of the series of mobile blades within a recess can then advantageously be obtained by any adequate means, a locking screw passing through the rotor for example.

According to the other embodiment, the present invention relates to a rotor for a turbocompressor comprising a succession of rotor stages, the rotor being common in this case to several stages with several series of mobile blades. In the particular case of a compressor having a rotor common to two rotor stages, the turbocompressor comprises two series of mobile blades and the rotor comprises an intermediate ring and two end rings. On each of its faces, the intermediate ring has half-profiles that correspond to the half-profiles present on each of the end rings so as to form again during assembly the two complete recesses for the mounting of the two series of mobile blades of the two successive rotor stages.

The generalization of this principle to several rotor stages (three, four or five) can of course be easily understood by the person skilled in the art.

The invention likewise relates to a turbocompressor comprising a stator and a rotor according to the invention, as defined above.

In the turbocompressor according to the invention, the stator comprises one or more stages comprising fixed blades alternating with the stages comprising the rotating blades of the rotor.

The turbocompressor according to the invention can be a turboblower, a turbojet or a gas turbine coupled to an alternator to produce electricity for example.

The invention has many advantages, both as regards the construction of the rotors and the operation of the turbocompressors. On the one hand, the construction of the rotors is simpler and cheaper due to the fact that it no longer requires costly machining of complete recesses in the rotor nor that of corresponding blade supports. On the other hand, it no longer requires to make lateral openings through the rotor for the passage of the blades, which simplifies the construction of the rotor and avoids the presence of highly stressed zones in the rotor. Since it no longer requires latches for retaining the blades on the rotor, the invention has the additional advantages of reducing the pressure losses in the flow of the fluid, of reducing the vibration in the turbocompressors and, above all, of reducing or eliminating the ovalisation of the rotor in operation. All things being equal moreover, it thus has the advantage of improving the efficiency of the turbocompressors and of reducing the mechanical stresses to which they are subjected.

Moreover, the manufacture of mobile blades without a platform or plate will be significantly easier compared with the production of the blades provided in the prior-art solutions.

This invention likewise has the advantage of providing a lighter rotor assembly due to the presence of a single wall instead of a double wall as in the prior art.

### BRIEF DESCRIPTION OF THE FIGURES

FIG. 1 represents a general view of a conventional turbocompressor.

FIG. 2 is a transverse cross-section view of part of a rotor according to the prior art.

FIG. 3 is a perspective exploded view of part of a rotor showing the locking elements formed by latches in order to fix the last blade in a recess according to the prior art.

FIG. 4 represents a transverse cross-section view of a rotor according to the prior art.

FIG. 5 is a transverse cross-section view of a rotor according to an embodiment which combines two particular embodiments of the present invention.

### DESCRIPTION OF THE PREFERRED EMBODIMENT OF THE INVENTION

In these figures, the same reference numerals designate identical elements.

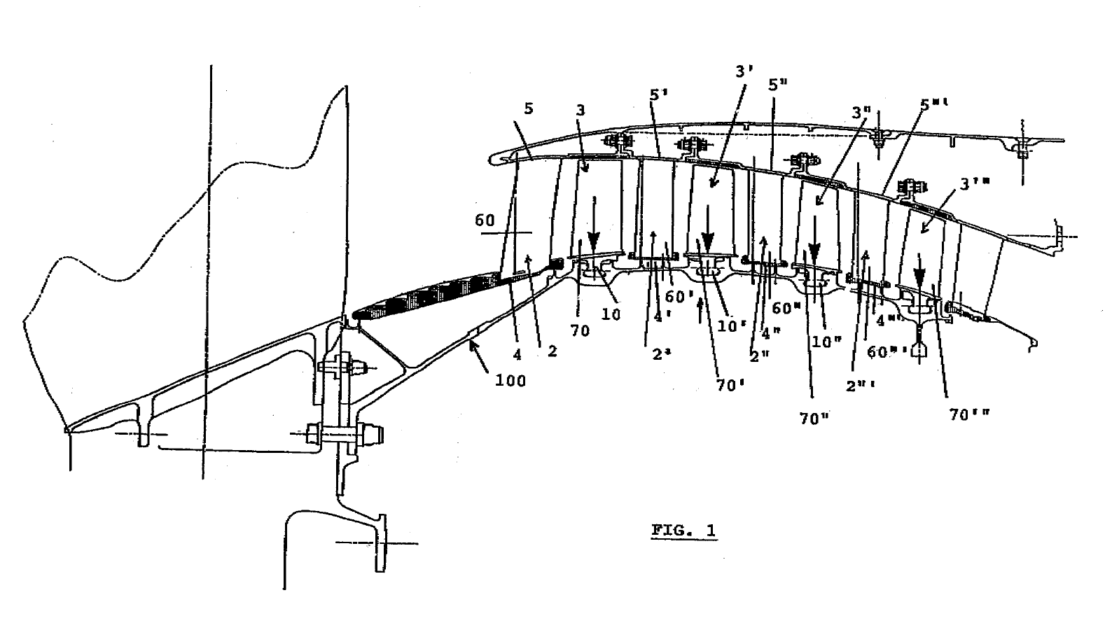

As illustrated in FIG. 1, the compression stage of a turbofan is traditionally made up of a series of rotor stages 3, 3′, 3″, . . . alternating with a series of stator or guide-vane stages 2, 2′, 2″, . . .

When the turbofan is operating, the gas first of all passes through the first guide-vane stage 2 of the compressor, where its speed vector is repositioned so as to be taken along by the second rotor stage 3′ of rotating blades before entering the second guide-vane stage 2′ so as to be repositioned again at 3″, etc. The gas thus undergoes a carrying-repositioning cycle, at the end of which its kinetic energy progressively decreases while its pressure increases.

In FIG. 1, only the first blade 70, 70′, 70″ for each rotor stage or 60, 60′, 60″ for each guide-vane stage is shown in cross-section for each stage.

Each rotor stage 3, 3′, 3″, . . . comprises a series of mobile blades 70, 71, 72, . . . and each guide-vane or stator stage 2, 2′, 2″, . . . comprises a series of fixed blades 60, 61, 62, . . . respectively.

Each guide-vane stage 2, 2′, 2Δ, . . . further comprises an internal barrel 4, 4′, 4″, . . . respectively linked to an external barrel 5, 5′, 5″, . . . respectively by the series of fixed blades 60, 61, 62, . . . ; 60′, 61′, 62′, . . . or 60″, 61″, 62″, . . . respectively. Said internal barrels 4, 4′, 4′″, . . . and said external barrels 5, 5′, 5″, . . . are thus proper to each of the guide-vane stages 2, 2′, 2″, . . .

Several series of mobile blades, 70, 71, 72; 70′, 71′, 72′, . . . respectively forming as many rotor stages 3, 3′, 3″, . . . are fixed on the rotor 100. There is thus one single rotor 100 for all the rotor stages 3, 3′, 3″ at the periphery of which recesses 10, 10′, 10″ are formed.

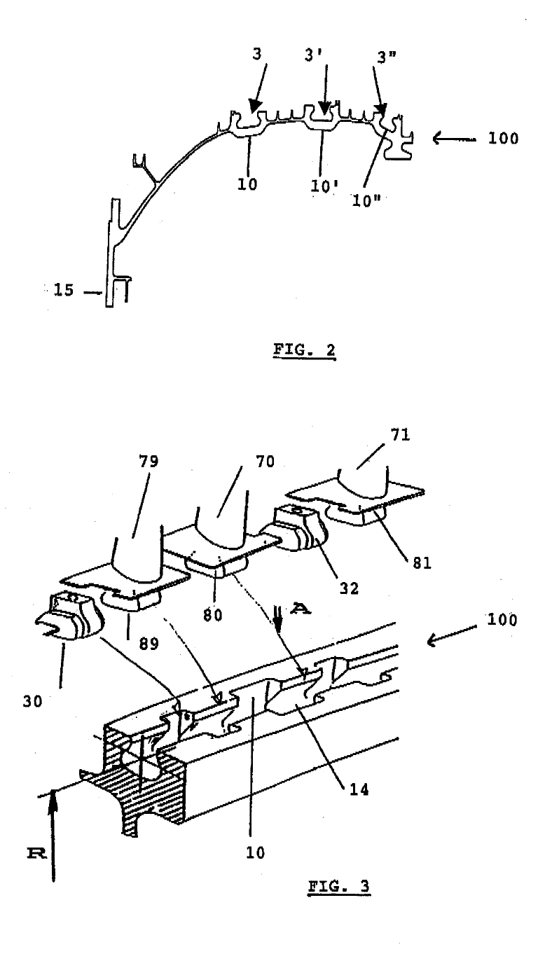

Such a rotor is shown in FIGS. 2 and 3 according to the technological background. It corresponds to an integral annular rotor 100 transversely fixed to a disc 15 (intended for example to be coupled to an engine). The rotor 100 is generally made of titanium. The recesses 10, 10′, 10″ are machined at its periphery and each corresponds to a rotor stage 3, 3′, 3″. The recesses 10, 10′, 10″ are intended to receive the roots 80, 81, 82, . . . ; 80′, 81′, 82′, . . . and 80″, 81″, 82″, . . . of the successive series of mobile blades 70, 71, 72, . . . ; 70′, 71′, 72′, . . . and 70″, 71″, 72″, . . .

FIG. 3 represents a recess 10 in which the roots 80, 81, 82, . . . 89 of the mobile blades 70, 71, 72, . . . 79 of a single rotor stage are successively housed.

To this end, lateral openings 14 are formed in said recess 10. After the last blade 79 is introduced, it is fixed by means of one or more locking elements 30, 32.

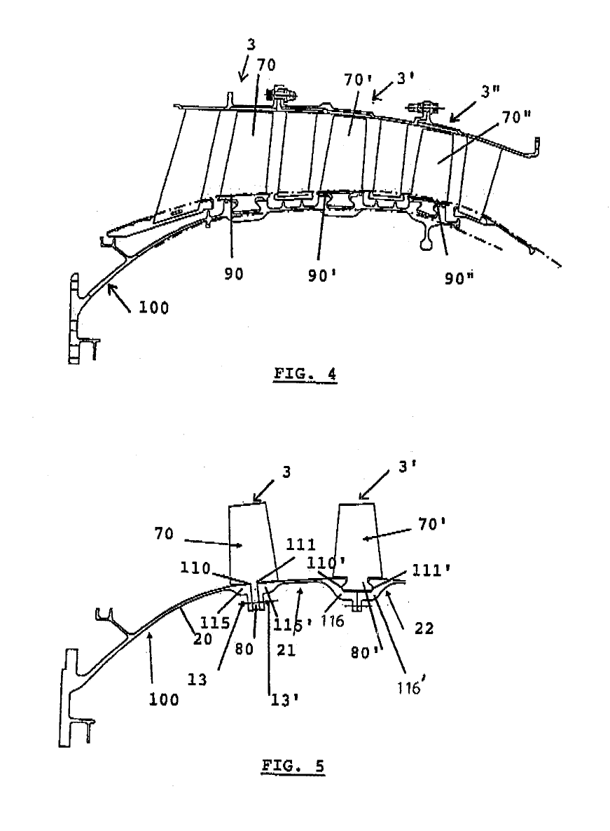

FIG. 4 represents the rotor according to the prior art, in which series of blades 70, 70′, 70″ produced according to the prior art have been represented for the various rotor stages 3, 3′, 3″.

These blades are blades having a platform or plate 90, 90′, 90″.

It is noted that each root 80, 80′ of a blade 70, 70′ is engaged in said recess 10, 10′ in such a way that a platform or plate 90, 90′ present at the level of the end portion of the mobile blade 70, 70′ above the root is capable of resting on the lips or edges of said recess.

These platforms or plates 90, 90′, . . . are essentially arranged perpendicularly to the functional portion (also referred to as an aerofoil) of said blade.

The presence of such plates gives rise to the presence of a double wall in the aerodynamic stream, one of the walls being directly constituted by the rotor 100 forming the support of the various rotor stages and the other wall being constituted by the platforms 90, 90′ of the mobile blades 70, 70′, . . .

With a view to resolving this problem, a rotor according to the present invention is shown in FIG. 5. It represents an imaginary view, in which two rotor stages are represented.

The first rotor stage 3 is constituted by a series of mobile blades 70, 71, . . . , all of which being similar and having a flat or rectilinear root 80, 81, . . . , while the second rotor stage 3′ has blades 70′, 71′, . . . , all of which being similar and having a root 80′, 81′, . . . in the form of a dovetail.

Consequently, as represented in the figure, the recesses 10 and 10′ intended to receive the roots of the first and second stages 3 and 3′ are differently shaped.

In practice however, it must be understood that only one and same profile will be used for the various recesses intended to produce the various rotor stages.

According to the present invention, the mobile blades do not have a platform or plate, which allows to directly generate the aerodynamic stream from the profile of the rotor 100.

This means that, according to the present invention, the various series of mobile blades 70, 71, . . . ; 70′, 71′, have a functional portion constituted by an aerofoil directly in contact with the corresponding root 80, 81, . . . ; 80′, 81′, . . . without the presence of platforms or plates essentially extending perpendicularly to said blade.

According to a particularly preferred embodiment of the present invention, the rotor 100 is constituted by at least two rings, and, in the present case, by three rings 20, 21 and 22.

According to the embodiment described in FIG. 5, the intermediate ring 21 has an annular half-profile 111, 110′ on each of its lateral faces, while the end rings 20 and 22 have an annular half-profile 110 and 111′ respectively on only one of their two lateral faces, corresponding to that (111 and 110′ respectively) arranged opposite on the ring to which it is adjacent. The juxtaposition of these half-profiles 110, 111; 110′, 111′ will allow to produce a complete recess 10, 10′ allowing the insertion of the roots 80, 81, . . . or 80′, 81′, . . . of the series of blades 70, 71, . . . or 70′, 71′, . . .

After placing said roots of said blades in the corresponding recesses, the rings 20, 21, 22 are firmly attached to one another so as to form the complete rotor 100.

The various rings are fixed by any appropriate means.

In the figure shown, the proposal is to produce flanges 115, 115′, 116, 116′ in which an opening is provided, through which a rod/bolt/nut assembly 13, 13′ passes.

In concrete terms, all that is required to fix the various series of mobile blades is to detach the various rings 20, 21, 22, to move them apart in order to open the recesses 10, 10′, . . . , to insert each series of roots 80, 81, 82, . . . of mobile blades 70, 71, 72, . . . between the two rings and then to bring back the rings 20, 21 towards one another and to juxtapose them in such a way as to capture and immobilize said roots in the respective recesses.

It will be noted that the profiles of the recesses and hence the half-profiles constituting them can take various forms that are different from those mentioned in the two preferred embodiments. These profiles can be dovetail-shaped, circular or polygonal. In the same way, the roots of the mobile blades can likewise be dovetail-shaped, circular or polygonal, provided that the profile of said roots of said mobile blades is complementary and corresponds to that of said recesses.

What is claimed is:

1. A rotor element for a turbocompressor having at least one rotor stage supporting a series of mobile blades that do not have a platform separating an aerofoil from a root of the blade, in which at least one recess is provided in order to allow the engagement of the roots of said mobile blades, wherein the rotor element comprises at least two consecutive individual rings having at their lateral periphery one annular half-profile which, during the axial juxtaposition of the at least two individual rings, form a complete recess in which the roots of the series of mobile blades are engaged.

2. The rotor element according to claim 1, wherein the two consecutive rings are fixed to each other in a removable or non-removable manner.

3. The rotor element according to claim 2, wherein the two consecutive rings are fixed to each other by an assembly of bolts or rivets linking flanges firmly attached to said rings.

4. The rotor element according claim 2, wherein the two consecutive rings are fixed to each other by an assembly by welding of said rings.

5. The rotor element according to claim 1, wherein the recess formed by assembly of said rings is dovetail-shaped, circular, polygonal or plane, in which the roots of complementary shape of the mobile blades are housed or engaged.

6. A turbocompressor comprising a rotor and a stator, wherein the rotor comprises a rotor element according to claim 1.

7. A turbocompressor comprising a rotor and a stator, wherein the rotor comprises a rotor element according to claim 2.

8. A turbocompressor comprising a rotor and a stator, wherein the rotor comprises a rotor element according to claim 3.

9. A turbocompressor comprising a rotor and a stator, wherein the rotor comprises a rotor element according to claim 4.

10. A turbocompressor comprising a rotor and a stator, wherein the rotor comprises a rotor element according to claim 5.

11. The turbocompressor according to claim 6, wherein it is a turboblower.

12. The turbocompressor according to claim 11, wherein it is a turbojet.

13. A blade intended for a rotor element according to claim 1, wherein it does not have a platform separating an aerofoil and a root of a blade and essentially extending perpendicularly to the blade.

14. Assembly of at least two individual rings to simultaneously form a rotor element according to claim 1 and the inner stream of the primary flow of a low pressure compressor, said individual rings comprising at their lateral periphery one annular half profile which, during the axial juxtaposition of the two individual rings, form a complete recess capable of receiving the roots of a series of mobile blades of a rotor stage, said blades having no platform essentially extending perpendicularly to the blades.
